(19) United States
(12) Patent Application Publication
(10) Pub. No.: US 2024/0354983 A1
(43) Pub. Date: Oct. 24, 2024

(54) SYSTEMS AND METHODS FOR DIGITAL IMAGE-BASED OBJECT AUTHENTICATION

(71) Applicant: ENT. SERVICES DEVELOPMENT CORPORATION LP, Houston, TX (US)

(72) Inventors: Naga Venkata Sitaram Ramachandrula, Bangalore (IN); Praloy Karmakar, Bangalore (IN); Mahmut Koray PERKÖZ, Brussels (BE)

(21) Appl. No.: 18/763,748

(22) Filed: Jul. 3, 2024

Related U.S. Application Data
(63) Continuation of application No. 18/331,989, filed on Jun. 9, 2023, now abandoned.
Application No. 18/331,989 is a continuation of application No. 17/500,577, filed on Oct. 13, 2021, now abandoned.
Application No. 17/500,577 is a continuation of application No. 16/376,300, filed on Apr. 5, 2019, now abandoned.

(51) Int. Cl. G06T 7/64; G06T 7/13; G06T 7/40; G06V 10/44; G06V 10/48; G06V 10/75; G06V 20/20

(52) U.S. Cl. CPC G06T 7/64; G06T 7/13; G06T 7/40; G06V 10/44; G06V 10/48; G06V 10/751; G06V 20/20

(57) ABSTRACT

Various embodiments of the present disclosure can include systems, methods, and non-transitory computer readable media configured to receive an input image associated with a test object. A set of edges are identified in the input image. A set of circles are identified based on the set of edges. A subset of circles is selected from the set of circles. The subset of circles is matched to a set of reference circles associated with a reference object. An authentication score is generated for the test object based on the matching of the subset of circles to the set of reference circles.

### FIELD OF THE INVENTION

The present technology relates to the field of digital image processing. More particularly, the present technology relates to digital image-based object authentication.

### BACKGROUND

Digital image processing technology has various applications. In certain applications, digital image processing technology can be used to automatically identify various objects that may be depicted in a digital image. In another example, digital image processing can be used not only to identify objects that may be depicted in a digital image, but also to analyze and draw conclusions about objects depicted in digital images.

### SUMMARY

Various embodiments of the present disclosure can include systems, methods, and non-transitory computer readable media configured to receive an input image associated with a test object. A set of edges are identified in the input image. A set of circles are identified based on the set of edges. A subset of circles is selected from the set of circles. The subset of circles is matched to a set of reference circles associated with a reference object. An authentication score is generated for the test object based on the matching of the subset of circles to the set of reference circles.

In an embodiment, the selecting the subset of circles from the set of circles comprises: calculating, for each circle of the set of circles, a confidence measure based on a number of edges falling on the circle, and selecting the subset of circles from the set of circles based on the confidence measures.

In another embodiment, for each circle of the set of circles, the confidence measure is calculated further based on at least one of: a number of expected edge pixels for the circle, a number of edge pixels detected for the circle, and a circumference of the circle.

In an embodiment, the selecting the subset of circles from the set of circles comprises: clustering the set of circles into a plurality of clusters, wherein the number of clusters in the plurality of clusters is determined based on the number of circles in the reference set of circles; calculating a confidence measure for each circle in the set of circles; and identifying, in each cluster of the plurality of clusters, a circle having the highest confidence measure within the cluster for inclusion in the subset of circles.

In an embodiment, the matching the subset of circles to a set of reference circles comprises: measuring a radius of each circle in the subset of circles to define a set of radii; determining an inverse radius of each radius in the set of radii to define a set of inverse radii; multiplying each radius of the set of radii by each inverse radius of the set of inverse radii to obtain a set of scaled radii values; obtaining a set of reference scaled radii values; and comparing the set of scaled radii values with the set of reference scaled radii values.

In an embodiment, the obtaining the set of reference scaled radii values comprises: measuring a reference radius of each circle in the set of reference circles to define a set of reference radii; determining an inverse reference radius of each reference radius of the set of reference radii to define a set of inverse reference radii; and multiplying each reference radius of the set of reference radii by each inverse reference radius of the set of inverse reference radii to obtain the set of reference scaled radii values.

In an embodiment, the generating the authentication score based on the matching of the subset of circles to the set of reference circles comprises: comparing a set of surface textures between each circle in the subset of circles with a set of reference surface textures.

In an embodiment, the authentication score is calculated based on the comparing the set of surface textures between each circle in the subset of circles with the set of reference surface textures and the matching the subset of circles to the set of reference circles.

In an embodiment, the set of circles comprises concentric circles.

In an embodiment, the input image is an image of a ball bearing and the method further comprises: determining whether the ball bearing is authentic based on the authentication score.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an image-based authentication module according to an embodiment of the present disclosure.

FIG. 2A illustrates an example optimal circle identification module according to an embodiment of the present disclosure.

FIG. 2B illustrates an example optimal circle matching module according to an embodiment of the present disclosure.

FIG. 3 illustrates an example scenario associated with identifying circles in an image according to an embodiment of the present disclosure.

FIG. 4 illustrates example scaling factors and scaled radii according to an embodiment of the present disclosure.

FIG. 5 illustrates a flowchart of an example method associated with generating an authentication score for a test object based on a matching of a set of circles identified in an image of the test object to a set of reference circles according to an embodiment of the present disclosure.

FIG. 6A illustrates a flowchart of an example method associated with generating an authentication score according to an embodiment of the present disclosure.

FIG. 6B illustrates a flowchart of an example method associated with retaining circles with higher confidences according to an embodiment of the present disclosure.

FIG. 7A illustrates a flowchart of an example method associated with identifying matching scaled radii according to an embodiment of the present disclosure.

FIG. 7B illustrates a flowchart of an example method associated with identifying matching scaled short radii and scaled long radii according to an embodiment of the present disclosure.

FIG. 8 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Digital Image-Based Object Authentication

Digital image processing technology has various applications. In certain applications, digital image processing technology can be used to automatically identify various objects that may be depicted in a digital image. In another example, digital image processing can be used not only to identify objects that may be depicted in a digital image, but also to analyze and draw conclusions about objects depicted in digital images.

In certain instances, digital image processing technology can be used to authenticate objects depicted in a digital image. Conventional approaches to using digital image processing for object authentication can be prohibitively difficult. For example, images captured at varying distances from the same object may produce images that look like differently sized objects. Likewise, images of the same object, if captured at varying resolutions and under varying lighting conditions, can produce images that do not appear to depict the same object. Some conventional approaches to digital image processing rely on identifying significant feature points in a digital image in order to identify and compare objects. However, such conventional approaches are generally unable to compare images of circular or symmetrical objects, which typically lack the feature points such approaches rely upon.

An improved approach rooted in computer technology overcomes the foregoing and other disadvantages associated with conventional approaches specifically arising in the realm of computer technology. Based on computer technology, the disclosed technology provides improved techniques for automated, image-based object authentication for processing digital images. In some embodiments, an optical device obtains an image of a test object, such as a ball bearing, that needs to be authenticated. The image of the test object is preprocessed to detect edges. In an embodiment, one or more circles are identified from the detected edges. A set of high confidence circles are identified from the one or more circles. The set of high confidence circles are each measured for radius values. The radius values are scaled relative to one another to obtain a set of scaled radius values. The set of scaled radius values is compared with a second set of scaled radius values. The second set of scaled radius values may be, for example, a reference set of scaled radius values that is associated with a reference object, such as an authentic ball bearing. By comparing the two sets of scaled radius values, it can be determined which circles, if any, from the two images match. If any matching circles are identified, the surface texture between the matching circles are compared. An authentication score (or multiple authentication scores) can be determined for the test object based on the comparison of the scaled radius values, the identification of any matching circles, and the comparison of the surface textures between the matching circles. An authentication score determined for a test object may be indicative of a likelihood that the test object (e.g., a test ball bearing) is identical to and/or otherwise matches a reference object (e.g., an authenticated reference ball bearing). Based on the authentication score or scores, it can be determined whether the test object matches the reference object. A determination of the authenticity of the test object may be made based on the authentication score(s).

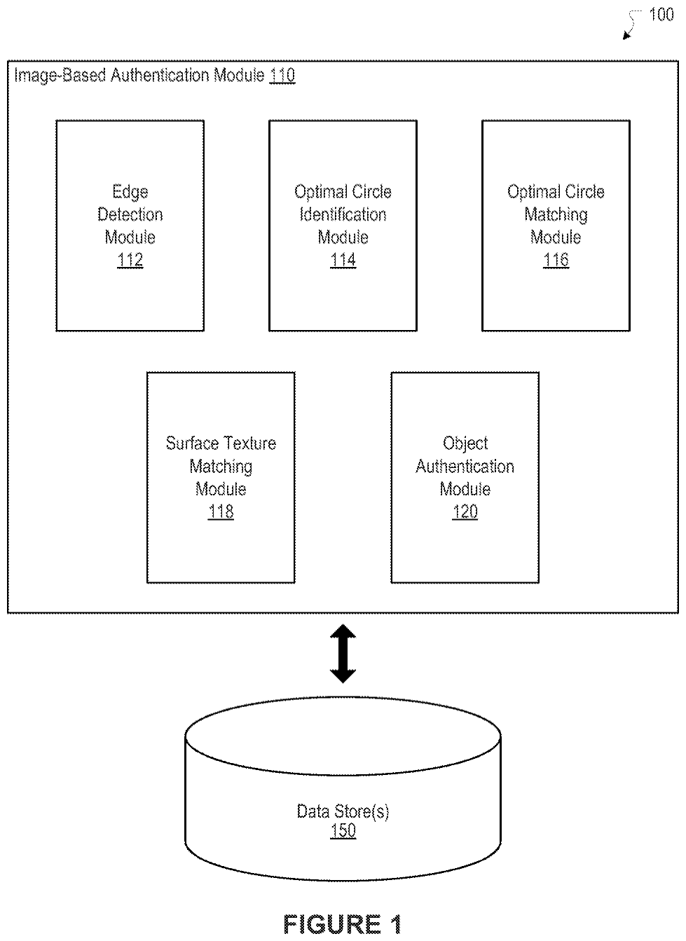

FIG. 1 illustrates an example system 100 including an image-based authentication module 110 according to an embodiment of the present disclosure. The image-based authentication module 110 can be configured to receive one or more images as input. For example, the one or more images may be digital images of a test object that needs to be authenticated. The image-based authentication module 110 can be configured to detect edges in the one or more images. In certain embodiments, the image-based authentication module 110 can identify circles or ellipses in the one or more images based on the detected edges. The image-based authentication module 110 can be configured to perform matching of the detected circles or ellipses with a set of circles or ellipses associated with a reference object. The reference object may be, for example, an object that has been authenticated, such that the test object can be compared with the reference object in order to authenticate the test object. The image-based authentication module 110 can also be configured to perform matching of surface texture on objects depicted in the one or more images. For example, surface textures in the one or more images of the test object may be compared to surface textures in one or more images associated with the reference object. The image-based authentication module 110 can generate an authentication score indicative of whether an object (e.g., the test object) matches another object (e.g., the reference object). The authentication score generated can be used to authenticate an object.

As shown in FIG. 1, the image-based authentication module 110 can include an edge detection module 112, an optimal circle identification module 114, an optimal circle matching module 116, a surface texture matching module 118, and an object authentication module 120. It should be noted that the components shown in this figure and all figures herein are exemplary only, and other implementations may include additional, fewer, integrated or different components. Some components may not be shown so as not to obscure relevant details.

In some embodiments, the various modules and/or applications described herein can be implemented, in part or in whole, as software, hardware, or any combination thereof. In general, a module and/or an application, as discussed herein, can be associated with software, hardware, or any combination thereof. In some implementations, one or more functions, tasks, and/or operations of modules and/or applications can be carried out or performed by software routines, software processes, hardware, and/or any combination thereof. In some cases, the various modules and/or applications described herein can be implemented, in part or in whole, as software running on one or more computing devices or systems, such as on a user or client computing device or on a server. For example, one or more modules and/or applications described herein, or at least a portion thereof, can be implemented as or within an application (e.g., app), a program, or an applet, etc., running on a user computing device or a client computing system. In another example, one or more modules and/or applications, or at least a portion thereof, can be implemented using one or more computing devices or systems that include one or more servers, such as network servers or cloud servers. It should be understood that there can be many variations or other possibilities.

As shown in FIG. 1, the image-based authentication module 110 can be configured to communicate with a data store 150. The data store 150 can be configured to store and maintain various types of data to facilitate the functionality of the image-based authentication module 110. For example, images of reference objects can be provided to the image-based authentication module 110. The image-based authentication module 110 can extract data, such as normalized or scaled radius values and surface textures, from the input images of the reference objects and store the extracted data in the data store 150. In some cases, the images of reference objects can be stored in the data store 150.

The edge detection module 112 can be configured to detect edges in an image. An edge can be detected, for example, based on transitions, changes, or discontinuities in the image. Many types of edges can be identified, such as horizontal edges, vertical edges, diagonal edges, and curved edges. In certain instances, multiple edges can be connected together to form a larger edge. Other edges may be fragmented or not connected. An edge can be comprised of multiple edge pixels. In some embodiments, the edge detection module may filter or otherwise process an image to facilitate detecting edges or edge pixels in the images.

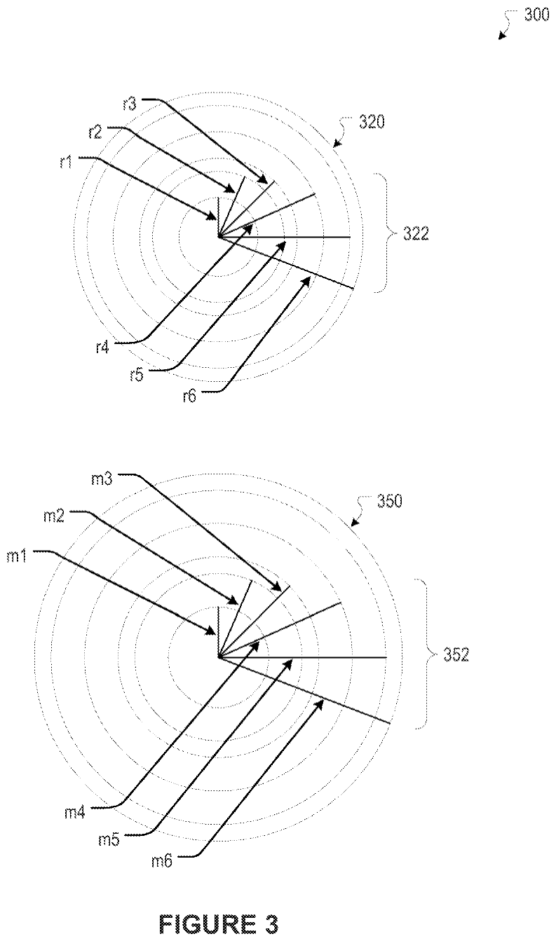

The optimal circle identification module 114 can be configured to identify one or more circles in an image based on the detected edges and/or edge pixels in an image. A circle can be detected from one or more edges or edge pixels identified in an image. Some circles may be detected from a small number of edges or edge pixels, and some circles may be detected from a large number of edges or edge pixels. By evaluating various factors, the optimal circle identification module 114 can identify a set of high confidence circles from the one or more circles. The features of the optimal circle identification module 114 are further described below with reference to FIG. 3.

In various embodiments, the optimal circle identification module 114 can be configured to detect circles, ellipses, circular shapes, elliptical shapes, and other variations, exclusively or in various combinations. Many variations are possible.

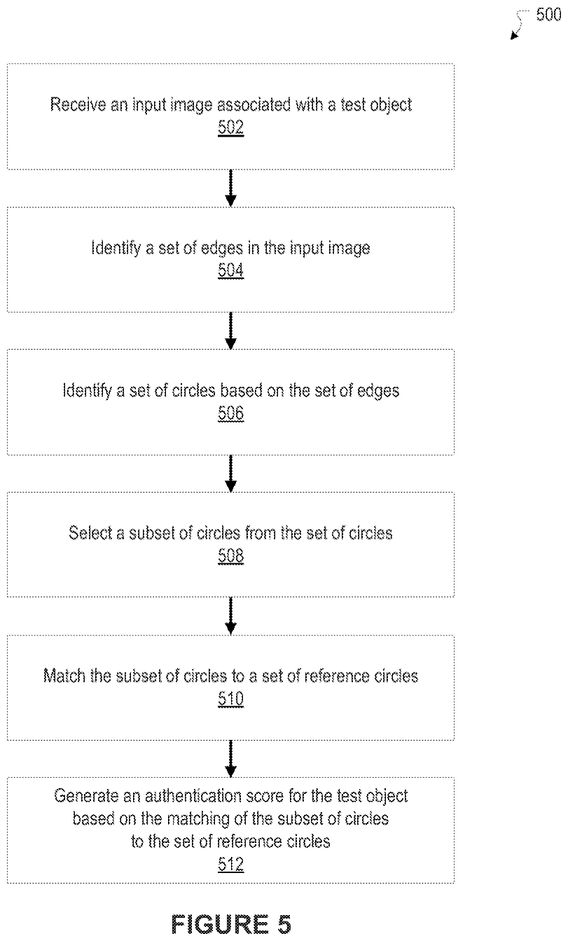

The optimal circle matching module 116 can be configured to compare two sets of circles. For example, the two sets of circles may have been identified from two images or two sets of images. In an embodiment, a first set of circles can be a set of high confidence circles identified in a first image (e.g., by the optimal circle identification module 114), and/or the second set of circles can be a set of high confidence circles identified in a second image. In an embodiment, one image (or one set of images) can be a test image (or a set of test images) associated with a test object to be authenticated. The other image (or set of images) can be a reference image (or a set of reference images) associated with a reference object. One or more circles can be detected in each image. By evaluating various factors, the optimal circle matching module 116 can identify which circles, if any, from the test image match circles in the reference image. The identification of matching circles in the two images can be used to determine whether the test image and the reference image are images of matching objects, i.e., whether the test object matches the reference object. The determination of whether the test image and the reference image are images of matching objects can be used to authenticate the test object in the test image. The features of the optimal circle matching module 116 are further described below with reference to FIG. 5.

In some embodiments, the optimal circle matching module 116 can be configured to match circles, ellipses, circular shapes, elliptical shapes, and other variations, exclusively or in various combinations. Many variations are possible.

The surface texture matching module 118 can be configured to compare object surfaces of a test object depicted in a test image with object surfaces of a reference object depicted in a reference image to determine whether the object surfaces of the two objects match one another. In an embodiment, the surface texture matching module 118 can receive matching circle information from the optimal circle matching module 116. As mentioned above, the optimal circle matching module 116 can be configured to identify one or more circles in a test object that correspond to or match one or more circles in a reference object. The matching circle information may identify which circles in a test object depicted in a test image correspond to which circles in a reference object depicted in a reference image. Between each matching circle in the sets of circles provided by the optimal circle matching module 116 is a circular area or an annular area. The surface texture matching module 118 can compare the surface texture of corresponding circular or annular areas in the test image and reference image. The comparison of the surface texture of corresponding circular or annular areas can be used as part of a determination as to whether the test image and the reference image are images of matching objects. The determination of whether the test image and the reference image are images of matching objects can be used to authenticate the test object in the test image.

In an embodiment, the surface texture matching module 118 compares the interior surface texture between the smallest circle in the test image and the smallest circle in the reference image. In an embodiment, the surface texture matching module 118 does not compare the surface texture between nonmatching circles. For example, if no matching circles are detected, then the surface texture matching module does not compare any surfaces. In some embodiments, the surface texture matching module 118 can be configured to match the surface texture between matching circles, ellipses, circular shapes, elliptical shapes, and other variations, exclusively or in various combinations. Many variations are possible.

The object authentication module 120 can be configured to determine an authentication score indicative of a likelihood that a test object depicted in a test image matches a reference object depicted in a reference image. In an embodiment, the object authentication module 120 can be configured to determine the authentication score based on matching of circles (e.g., based on matching of scaled radii) and/or based on surface matching for the test object and the reference object. In an embodiment, if the authentication score exceeds a threshold, then the test object and the reference object can be determined to be matching objects.

In some embodiments, the object authentication module 120 determines the authentication score based on a plurality of match scores. For example, it may be determined that there are six pairs of matching image regions found between a test image of a test object and a reference image of a reference object. This determination may be made, for example, based on matching circles identified by the optimal circle matching module 116. Furthermore, the surface texture matching module 118 can then determine six match scores indicative of how well each image region in the test image matches a corresponding image region in the reference image. In this example embodiment, the authentication score can be, for example, a sum or average of the plurality of match scores. In an embodiment, the authentication score can be based on an image-region comparison approach based on, for example, a probability distribution divergence from one matching image region to the next matching image region. In an embodiment, the authentication score can be based on a statistical measure. The authentication score can be presented in various ways, such as a percentage value, an average, or a normalized sum.

In an embodiment, multiple authentication scores can be generated. The multiple authentication scores can correspond to various matching factors. In one embodiment, a first authentication score can be associated with matching of circles in two images and/or objects, and a second authentication score can be associated with surface matching of the two images and/or objects. For example, if it is determined that seven of ten circles detected in a test image of a test object match circles detected in a reference image of a reference object, and the surfaces between the seven circles that matched are identical, then a first authentication score can indicate a 70% circle match and a second authentication score can indicate a 100% surface match. In an embodiment, multiple authentication scores can correspond to authentication scores of multiple test images of a test object. For example, a first test image of the test object may yield a first authentication score (or first set of authentication scores), a second test image of the test object may yield a second authentication score (or second set of authentication scores), and so forth. The multiple authentication scores can be averaged or otherwise normalized or combined to produce an overall authentication score. The overall authentication score may be indicative of the likeliness that the test object matches a reference object and is, therefore, authentic.

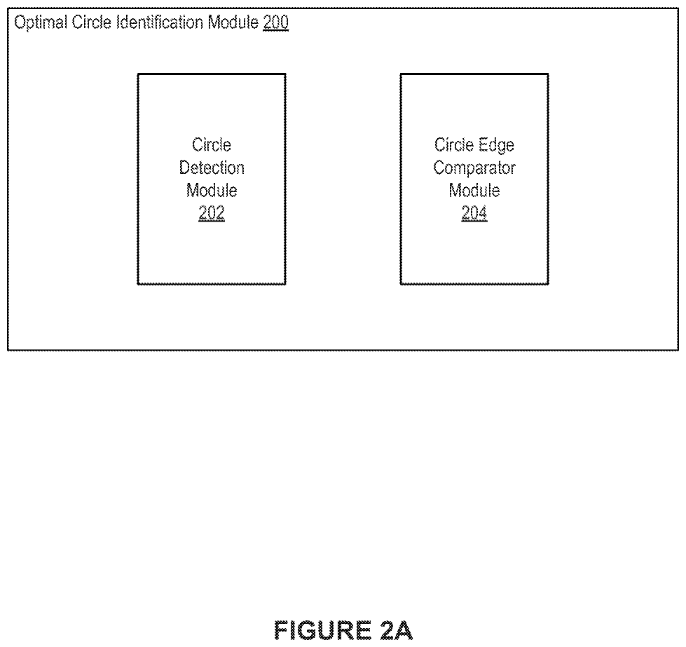

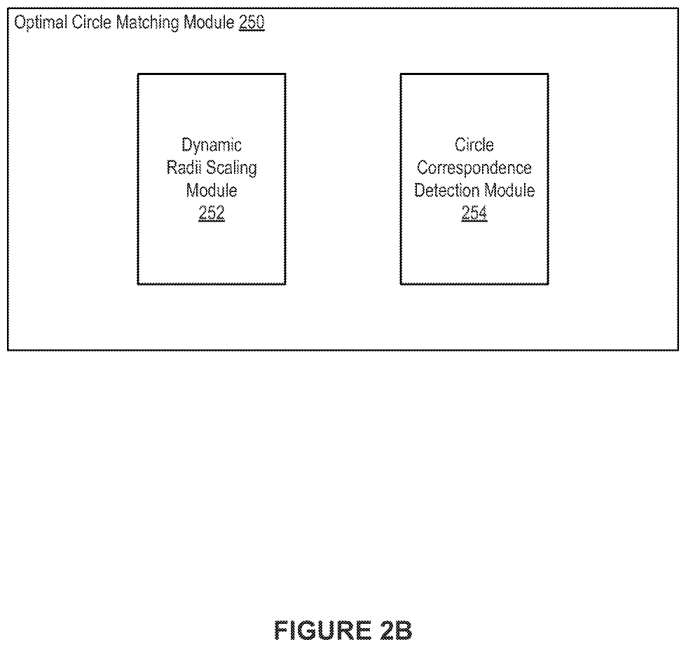

FIG. 2A illustrates an example optimal circle identification module 200 according to an embodiment of the present disclosure. In some embodiments, the optimal circle identification module 114 of FIG. 1 can be implemented as the optimal circle identification module 200. As shown in the example of FIG. 2, the optimal circle identification module 200 can include a circle detection module 202 and a circle edge comparator module 204.

The circle detection module 202 can be configured to identify circles in an image based on a set of edges and/or edge pixels detected in the image (e.g., by the edge detection module 112 in FIG. 1). In an embodiment, the circle detection module 202 can be configured to identify concentric circles. In a further embodiment, the circle detection module 202 can be configured to identify the location of an object of interest (e.g., a ball bearing) based on identification of concentric circles in an image. For example, a depiction of a ball bearing may make up a relatively small portion of an image. The location the ball bearing within the image can be determined (e.g., as a set of coordinates) by identifying a set of concentric circles in the image, and determining that the center of the ball bearing is located at the center of the set of concentric circles, and/or that an outermost concentric circle corresponds to an outer edge of the ball bearing. Although the example of circles is used in various embodiments discussed herein, in different embodiments, the circle detection module 202 can be configured to identify circles, ellipses, circular shapes, elliptical shapes, and other variations, exclusively or in various combinations. Many variations are possible.

The circle edge comparator module 204 can be configured to identify, from one or more circles identified by the circle detection module 202, a set of high confidence circles. In an embodiment, each circle identified by the circle detection module 202 is associated with and/or defined by one or more edges and/or one or more edge pixels. The circle edge comparator module 204 can be configured to identify a set of high confidence circles based on the number of edges and/or edge pixels associated with each circle. For example, each circle that satisfies a threshold number of edges and/or a threshold number of edge pixels can be selected for inclusion in the set of high confidence circles. The threshold number of edges and/or edge pixels required for inclusion in the set of high confidence circles may vary depending on a variety of factors, such as image resolution and image quality. For example, if an image is a low-quality image, with a low resolution, captured under poor conditions, the threshold number of edges or edge pixels required for inclusion in the set of high confidence circles may be lower. Conversely, if an image is a high-quality image, with a high resolution, captured under ideal conditions, then the circle edge comparator module 204 may set a higher threshold for inclusion in the set of high confidence circles.

In an embodiment, the circle edge comparator module 204 can identify the set of high confidence circles based on a variety of factors. For example, a number of expected edge pixels for a high confidence circle can be calculated and the number of expected edge pixels for a high confidence circle can be compared with a number of edge pixels detected for a detected circle. The number of expected edge pixels can be calculated based on, for example, image resolution and image quality. If an image is a high-quality image, with a high resolution, then the circle edge comparator module 204 can calculate that a high confidence circle should have a high number of expected edge pixels. In this example, if a detected circle has a number of detected edge pixels that exceeds the number of expected edge pixels, then the detected circle can be selected for inclusion in a set of high confidence circles. In another example, the threshold number of edges and/or edge pixels required for selecting a particular detected circle for inclusion in the set of high confidence circles may be determined based on the circumference of the particular detected circle. If the particular circle has a relatively large circumference compared to other detected circles, then the threshold number of edges or edge pixels required for selecting the particular detected circle for inclusion in the set of high confidence circles may be higher than the threshold number required for the other detected circles.

In an embodiment, the circle edge comparator module 204 can identify one or more groups of detected circles and choose, from each group of detected circles, a circle with a highest confidence. For example, a test object in a test image may be compared to a reference object in a reference image, wherein the reference object is determined to comprise six circles. The test image may be analyzed and twenty circles may be identified in the test object depicted in the test image. In this example, the twenty detected circles from the test image can be grouped into six groups, since it is known that the reference image of the reference object has six circles. Each of the six groups of circles can be determined based on proximity of circles to each other, proximity of circles to an expected location, or other factors. From each group of circles, a circle with a highest confidence (e.g., a highest number of edges and/or edge pixels) can be selected for inclusion in the set of high confidence circles.

FIG. 2B illustrates an example optimal circle matching module 250 according to an embodiment of the present disclosure. In some embodiments, the optimal circle matching module 116 of FIG. 1 can be implemented as the optimal circle matching module 250. As shown in FIG. 2B, the optimal circle matching module 250 can include a dynamic radii scaling module 252 and a circle correspondence detection module 254.

The dynamic radii scaling module 252 can be configured to normalize radii of a set of circles and negate scaling or magnification effects that may have affected the set of circles. The set of circles may be, for example, a set of high confidence circles associated with a test object and identified by the circle edge comparator module 204 in FIG. 2A. In another example, the set of circles may be a set of circles and/or a set of high confidence circles associated with a reference object. In an embodiment, the dynamic radii scaling module 252 measures (e.g., in pixels) the radius of each circle in a set of circles. The inverse of each radius measurement is taken to determine a set of scaling factors. For example, a radius measurement R1 can have an inverse 1/R1. Each radius measurement is multiplied by each scaling factor in the set of scaling factors to obtain a matrix of scaled radii corresponding to the set of circles received by the dynamic radii scaling module 252. Each row in the matrix of scaled radii corresponds to each radius measurement multiplied by a scaling factor and each column in the matrix of scaled radii corresponds to each scaling factor multiplied by a radius measurement. In other words, each row in the matrix of scaled radii corresponds to one scale or magnification for the set of circles and each column corresponds to the same circle under different scalings.

In an embodiment, the dynamic radii scaling module 252 can be configured to receive a set of ellipses. The dynamic radii scaling module 252 measures (e.g., in pixels) the short radius and long radius of each ellipse in the set of ellipses. The inverse of each short radius measurement and long radius measurement is taken to determine a set of short scaling factors and a set of long scaling factors. Each short radius measurement is multiplied by each short scaling factor in the set of short scaling factors to obtain a matrix of scaled short radii. Likewise, each long radius measurement is multiplied by each long scaling factor in the set of long scaling factors to obtain a matrix of scaled long radii. Each row in the matrix of scaled short radii and scaled long radii corresponds, respectively, to one short scaling and one long scaling applied to the set of ellipses. Each column in the matrix of scaled short radii and matrix of scaled long radii corresponds, respectively, to the same ellipse under different scalings.

In an embodiment, the dynamic radii scaling module 252 can normalize a set of ellipses based on center and orientation, and can measure the latitudinal radius and longitudinal radius (e.g., in pixels) of each scaled ellipse in the set of ellipses. The inverse of each latitudinal radius measurement and longitudinal radius measurement can be taken to determine a set of latitudinal scaling factors and a set of longitudinal scaling factors. Each latitudinal radius measurement can be multiplied by each latitudinal scaling factor in the set of latitudinal scaling factors to obtain a matrix of scaled latitudinal radii. Likewise, each longitudinal radius measurement can be multiplied by each longitudinal scaling factor in the set of longitudinal scaling factors to obtain a matrix of scaled longitudinal radii. Each row in the matrix of scaled latitudinal radii and scaled longitudinal radii corresponds, respectively, to one latitudinal scaling and one longitudinal scaling applied to the set of ellipses. Each column in the matrix of scaled latitudinal radii and matrix of scaled longitudinal radii corresponds, respectively, to the same ellipse under different scalings.

The circle correspondence detection module 254 can be configured to identify matching circles between two sets of circles. In an embodiment, the circle correspondence detection module 254 receives a test matrix of scaled radii from the dynamic radii scaling module 252 that corresponds with a test image of a test object to be authenticated and compares that with a reference matrix of scaled radii that corresponds with a reference image of an authentic reference object. The test matrix and the reference matrix may have different numbers of rows and columns. This may occur, for example, if more circles are detected in a test image than in a reference image, or more circles are detected in a reference image than in a test image. The circle correspondence detection module 254 identifies matching values from the test matrix and reference matrix to determine matching circles.

In an embodiment, the circle correspondence detection module 254 generates a confidence measure based on matching values from a test matrix and a reference matrix. For example, if each row of a test matrix associated with a test object matches a row of a reference matrix associated with a reference object, then the test object can be considered to be a match of the authentic reference object and, therefore, authentic. In another example, some, but not all, of the scaled radii in a row of a test matrix may match values in one row of a reference matrix. In this example, the nonmatching scaled radii in the row of the test matrix may be due to either nonmatching or missing circles in the test object. Nonmatching circles may indicate that the test object is not a match of the authentic reference object. Missing circles may indicate a poor-quality image from which the test matrix was determined. If a substantially low number of scaled radii in the row of the test matrix match values in a row of the reference matrix (e.g., below a threshold number of scaled radii), then it is likely that the nonmatching scaled radii correspond to nonmatching circles. Accordingly, the test object is not likely to match the authentic reference object, and can, therefore, be determined to be not authentic. On the other hand, if not all, but a high number of scaled radii in the row of the test matrix match values in a row of the reference matrix (e.g., above a threshold number of scaled radii), then it is likely that the nonmatching scaled radii correspond to missing circles. Accordingly, the test object may still match the authentic reference object even though not every scaled radius matched values in one row of the reference matrix. The test object may still be authentic.

In an embodiment, the circle correspondence detection module 254 can be configured to identify matching ellipses between two sets of ellipses. The circle correspondence detection module 254 can receive a test matrix of scaled short radii and a test matrix of scaled long radii that correspond with a test image of a test object to be authenticated and compares the matrices with a reference matrix of scaled short radii and a reference matrix of scaled long radii that correspond with a reference image of an authentic reference object. The circle correspondence detection module 254 can identify values in the test matrix of scaled short radii and test matrix of scaled long radii that match the values in the reference matrix of scaled short radii and the reference matrix of scaled long radii. If greater than a threshold number of scaled short radii and/or scaled long radii associated with the test object match scaled short radii and/or scaled long radii associated with the reference object, the test object can be determined to match the reference object.

In an embodiment, the circle correspondence detection module 254 can be configured to identify matching circles, ellipses, circular shapes, elliptical shapes, and other variations, exclusively or in various combinations. Many variations are possible.

FIG. 3 illustrates an example scenario 300 of a test set of circles 320 and a reference set of circles 352, according to an embodiment of the present disclosure. The test set of circles 320 can correspond to a set of high confidence circles detected from edges and/or edge pixels in a test image of a test object. Similarly, the reference set of circles 352 can correspond to a set of high confidence circles detected from edges and/or edge pixels in a reference image of a reference object. The test set of circles 320 contains a set of six circles. From the six circles, a set of test radii 322 can be measured. The set of test radii 322 contains six radii, r1, r2, r3, r4, r5, and r6. These radii can be scaled by taking the inverse of each radius (i.e., 1/r1, 1/r2, 1/r3, 1/r4, 1/r5, and 1/r6) and multiplying each radius (i.e., r1, r2, r3, r4, r5, and r6) by the inverse of each radius. Similarly, the reference set of circles 350 contains a set of six circles. From the six circles, a set of reference radii 352 can be measured. The set of reference radii 352 contains six radii, m1, m2, m3, m4, m5, and m6. These radii can be scaled by taking the inverse of each radius (i.e., 1/m1, 1/m2, 1/m3, 1/m4, 1/m5, and 1/m6) multiplying each radius (i.e., m1, m2, m3, m4, m5, and m6) by the inverse of each radius. By comparing the scaled radii from the test set of circles 320 and the reference set of circles 352, it can be determined whether the test object and the reference object match even though the test image and the reference image produce differently sized sets of circles.

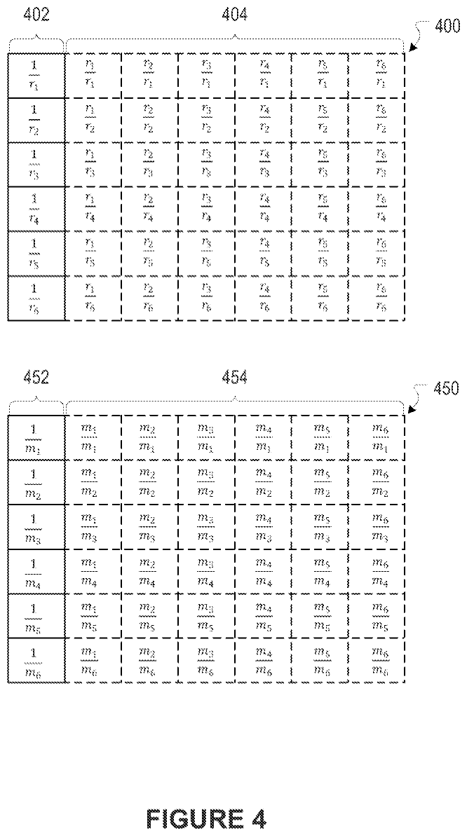

FIG. 4 illustrates example matrices 400, 450 which correspond to the example scenario 300 of FIG. 3. The example matrix 400 includes a test set of scaling factors 402 and a test matrix of scaled radii 404, which correspond to the test set of circles 320 of FIG. 3. The example matrix 450 includes a reference set of scaling factors 452 and a reference matrix of scaled radii 450 which correspond to the reference set of circles 350 of FIG. 3. The test set of scaling factors 402 comprises the inverse of six measured radii, r1, r2, r3, r4, r5, and r6, from the test set of circles 320. The test matrix of scaled radii 404 comprises each measured radius (i.e., r1, r2, r3, r4, r5, and r6) multiplied by each scaling factor in the test set of scaling factors 402. Each row in the test matrix of scaled radii 404 corresponds to each measured radius multiplied by a scaling factor and each column in the test matrix of scaled radii 404 corresponds to each scaling factor multiplied by a measured radius. In other words, each row in the test matrix of scaled radii 404 corresponds to one scale or magnification for the test set of circles and each column corresponds to each circle under different scalings.

The reference set of scaling factors 452 comprises the inverse of six measured radii, m1, m2, m3, m4, m5, and m6, from the reference set of circles 350. The reference matrix of scaled radii 454 comprises each measured radius (i.e., m1, m2, m3, m4, m5, and m6) multiplied by each scaling factor in the reference set of scaling factors 452. Each row in the reference matrix of scaled radii 454 corresponds to each measured radius multiplied by a scaling factor and each column in the reference matrix of scaled radii 404 corresponds to each scaling factor multiplied by a measured radius. In other words, each row in the reference matrix of scaled radii 454 corresponds to one scale or magnification for the reference set of circles and each column corresponds to each circle under different scalings. By identifying matching values from the test matrix of scaled radii 452 and the reference matrix of scaled radii 454, it can be determined whether the test set of circles and the reference set of circles match, even if they have different radii.

In the example scenario shown in FIGS. 3 and 4, the test set of circles and the reference set of circles have the same number of circles. However, even if each set of circles has a different number of circles, the two sets (e.g., matrices) of scaled radii can be compared in order to authenticate the test object. For example, consider an example scenario in which the reference object has 12 circles, but only 6 circles are detected in the test object. The difference may have occurred, for example, due to a low quality image of the test object, or possibly inaccurate detection of circles in the test image. However, for each row of the test matrix, it can be determined whether a particular row of the reference matrix contains each value contained in the row of the test matrix. For example, consider a test object that has circles of the following radii: 30, 40, 70, 120, 150, and 180 pixels. This may result in the following test matrix:

| | | | | | |
|---|---|---|---|---|---|
| 1 | 1.3333 | 2.3333 | 4 | 5 | 6 |
| 0.75 | 1 | 1.75 | 3 | 3.75 | 4.5 |
| 0.4286 | 0.5714 | 1 | 1.7143 | 2.1429 | 2.5714 |
| 0.25 | 0.3333 | 0.5833 | 1 | 1.25 | 1.5 |
| 0.2 | 0.2667 | 0.4667 | 0.8 | 1 | 1.2 |
| 0.1667 | 0.2222 | 0.3889 | 0.6667 | 0.8333 | 1 |

Next, consider a reference object that has circles of the following radii: 51, 68, 93.5, 119, 122.4, 204, 205.7, 255, and 306 pixels. This may result in the following reference matrix:

| | | | | | | | | |
|---|---|---|---|---|---|---|---|---|
| 1 | 1.3333 | 1.8333 | 2.3333 | 2.4 | 4 | 4.0333 | 5 | 6 |
| 0.75 | 1 | 1.375 | 1.75 | 1.8 | 3 | 3.025 | 3.75 | 4.5 |
| 0.5455 | 0.7273 | 1 | 1.2727 | 1.3091 | 2.1818 | 2.2 | 2.7273 | 3.2727 |
| 0.4286 | 0.5714 | 0.7857 | 1 | 1.0286 | 1.7143 | 1.7286 | 2.1429 | 2.5714 |
| 0.4167 | 0.5556 | 0.7639 | 0.9722 | 1 | 1.6667 | 1.6806 | 2.0833 | 2.5 |
| 0.25 | 0.3333 | 0.4583 | 0.5833 | 0.6 | 1 | 1.0083 | 1.25 | 1.5 |
| 0.2479 | 0.3306 | 0.4545 | 0.5785 | 0.5950 | 0.9917 | 1 | 1.2397 | 1.4876 |
| 0.2 | 0.2667 | 0.3667 | 0.4667 | 0.48 | 0.8 | 0.8067 | 1 | 1.2 |
| 0.1667 | 0.2222 | 0.3056 | 0.3889 | 0.4 | 0.6667 | 0.6722 | 0.8333 | 1 |

In this example scenario, it can be seen that the first row of the test matrix is entirely contained within the first row of the reference matrix, the second row of the test matrix is entirely contained within the second row of the reference matrix, the third row of the test matrix is entirely contained within the fourth row of the reference matrix, the fourth row of the test matrix is entirely contained within the sixth row of the reference matrix, the fifth row of the test matrix is entirely contained within the eighth row of the reference matrix, and the sixth row of the test matrix is entirely contained within the ninth row of the reference matrix. In this case, every row of the test matrix matches at least one row of the reference matrix, indicating a high likelihood that the test object matches the reference object. The foregoing is an example scenario. Many other scenarios are possible.

FIG. 5 illustrates a flowchart of an example method 500 associated with generating an authentication score for a test object based on a matching of a set of circles identified in an image of the test object to a set of reference circles according to an embodiment of the present disclosure. It should be understood that there can be additional, fewer, or alternative steps performed in similar or alternative orders, or in parallel, based on the various features and embodiments discussed herein unless otherwise stated.

As shown in FIG. 5, at block 502, the example method 500 can receive an input image associated with a test object. The test object can be an object to be authenticated. At block 504, the example method 500 identifies a set of edges in the input images. At block 506, the example method 500 identifies a set of circles based on the set of edges. At block 508, the example method 500 selects a subset of circles from the set of circles. At block 510, the example method 500 matches the subset of circles to a set of reference circles. At block 512, the example method 500 generates an authentication score for the test object based on the matching of the subset of circles to the set of reference circles.

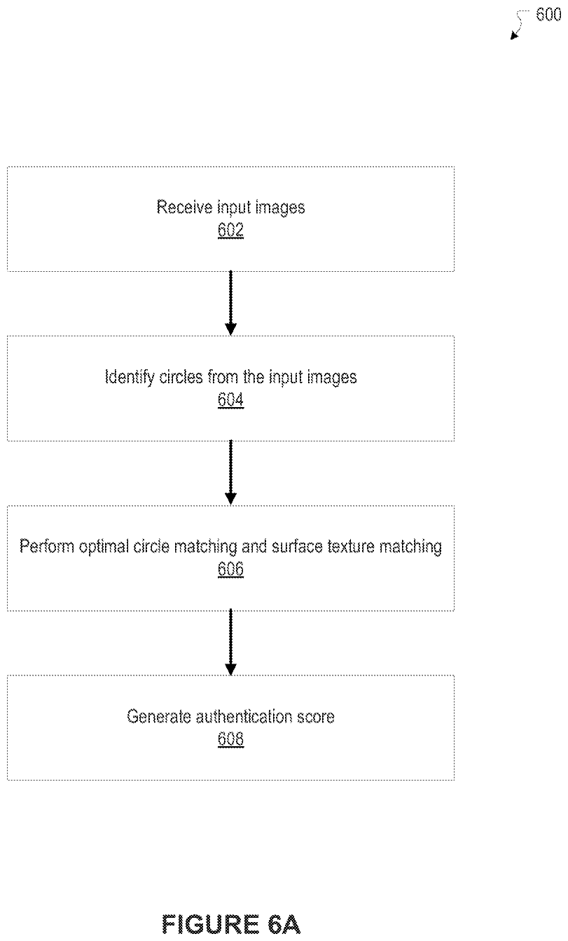

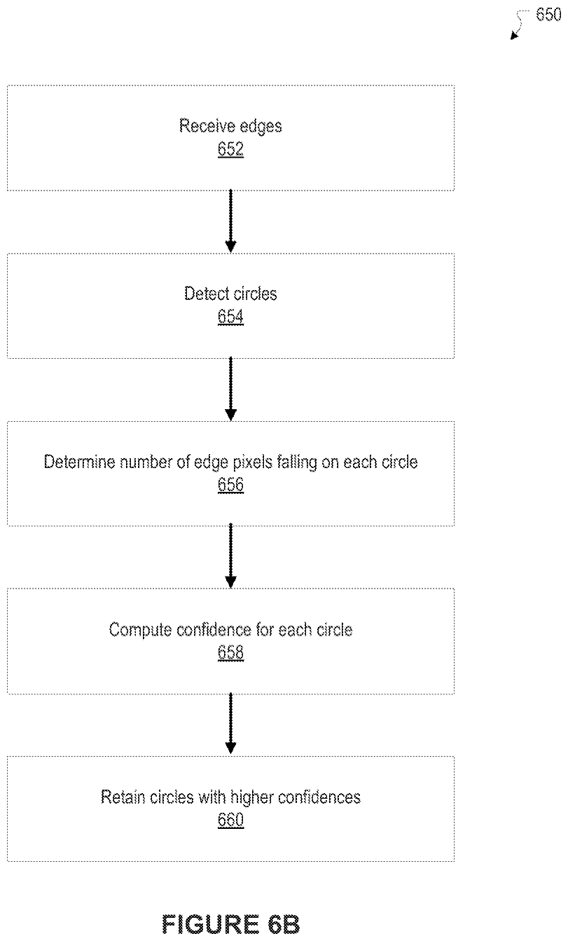

FIG. 6A illustrates a flowchart of an example method 600 associated with generating an authentication score according to an embodiment of the present disclosure. It should be understood that there can be additional, fewer, or alternative steps performed in similar or alternative orders, or in parallel, based on the various features and embodiments discussed herein unless otherwise stated.

As shown in FIG. 6A, at block 602, the example method 600 can receive input images. At block 604, the example method identifies circles from the input images. Identifying circles from the input images can include detecting edges and/or edge pixels in the input images. At block 606, the example method 500 can perform optimal circle matching and surface texture matching. The optimal circle matching and surface texture matching can be based on the circles or ellipses identified at block 604. At block 608, the example method 600 generates an authentication score based on the performed optimal circle matching and surface texture matching.

FIG. 6B illustrates a flowchart of an example method 650 associated with retaining circles with higher confidences according to an embodiment of the present disclosure. It should be understood that there can be additional, fewer, or alternative steps performed in similar or alternative orders, or in parallel, based on the various features and embodiments discussed herein unless otherwise stated.

As shown in FIG. 6B, at block 652, the example method 650 can receive edges. The edges can be detected from an image and can be comprised of edge pixels. At block 654, the example method 650 detects circles. The circles can be detected from the edges received in block 652. The circles can be concentric circles. Circles may be detected from a small number of edges or a large number of edges. At block 656, the example method 650 determines a number of edge pixels falling on each circle. At block 658, the example method 650 computes a confidence for each circle. The confidence can be based on the number of edge pixels falling on each circle. The confidence can also be based on a variety of factors such as circle circumference, image resolution, and image quality. At block 660, the example method 650 retains circles with higher confidences. The circles with higher confidences can be used to match circles from a test image of an object to be authenticated with the circles from a reference image of an authentic object.

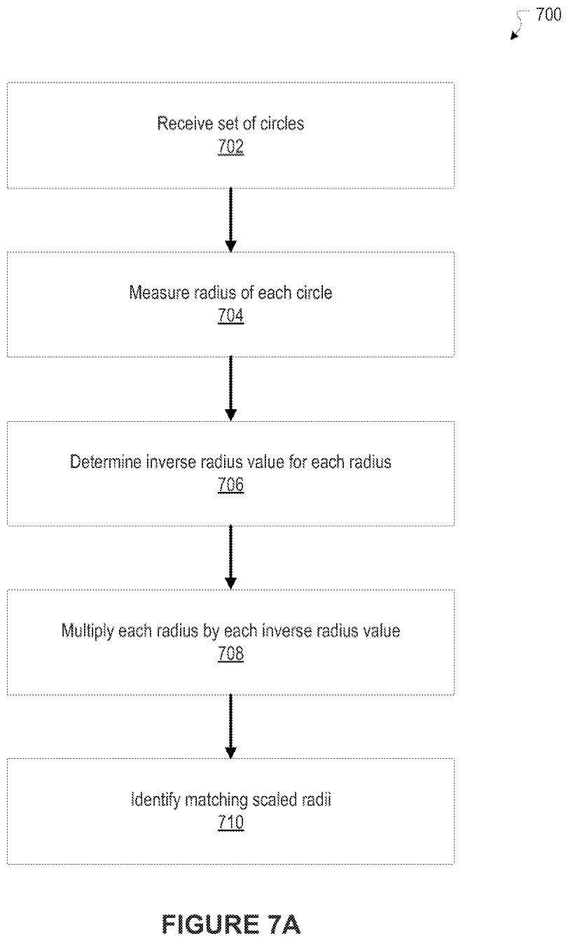

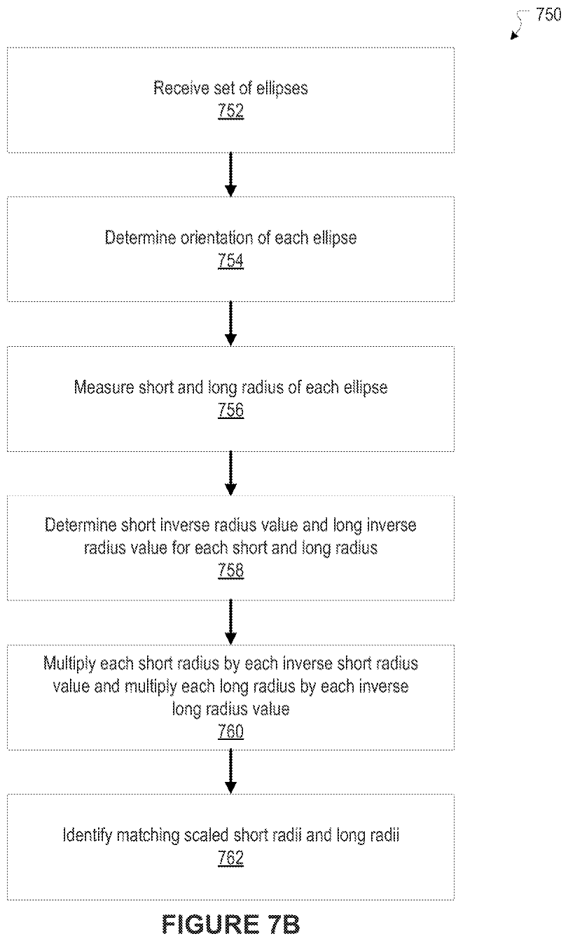

FIG. 7A illustrates a flowchart of an example method 700 associated with identifying matching scaled radii. It should be understood that there can be additional, fewer, or alternative steps performed in similar or alternative orders, or in parallel, based on the various features and embodiments discussed herein unless otherwise stated.

As shown in FIG. 7A, at block 702, the example method 700 can receive a set of circles. The circles can be detected from edges or edge pixels detected from an image. At block 704, the example method 700 can measure the radius of each circle. The radius of each circle can be measured from a common center if the set of circles is a set of concentric circles. The measurement can be in pixels. At block 706, the example method 700 can determine the inverse value of each radius. The inverse values can be scaling or magnification factors. At block 708, the example method 700 can multiply each radius by each inverse value. The result of multiplying each radius by each inverse value can be a matrix of scaled radii values. At block 710, the example method 700 can identify matching scaled radii.

FIG. 7B illustrates a flowchart of an example method 750 associated with identifying matching scaled short radii and scaled long radii. It should be understood that there can be additional, fewer, or alternative steps performed in similar or alternative orders, or in parallel, based on the various features and embodiments discussed herein unless otherwise stated.

As shown in FIG. 7B, at block 752, the example method 750 can receive a set of ellipses. The ellipses can be detected from edges or edge pixels detected from an image. At block 754, the example method 750 can determine the orientation of each ellipse. At block 756, the example method 750 can measure the short and long radius of each ellipse. The short and long radius of each ellipse can correspond to the latitudinal and longitudinal radius of each ellipse if each ellipse is oriented the same way. The short and long radius of each ellipse can be measured from a common center if the set of ellipses is a set of concentric ellipses. The measurements can be in pixels. At block 758, the example method 750 can determine the short inverse radius value and long inverse radius value for each short and long radius. The inverse values can be scaling or magnification factors. At block 760, the example method 750 multiples each short radius by each inverse short radius value and multiplies each long radius by each long radius value. The result is a matrix of scaled short radii values and a matrix of scaled long radii values. At block 762, the example method 750 identifies matching scaled short radii and long radii.

### Hardware Implementation

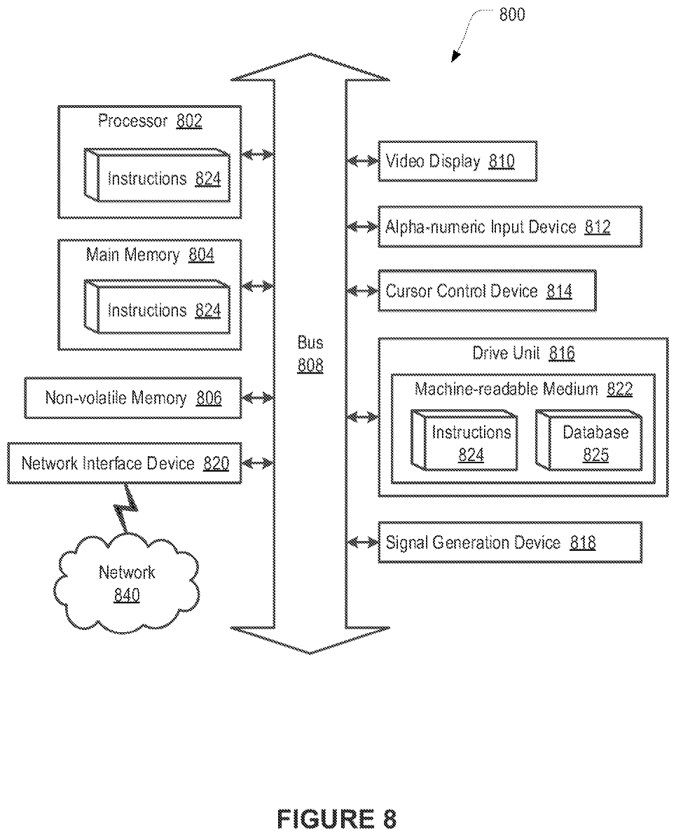

The foregoing processes and features can be implemented by a wide variety of machine and computer system architectures and in a wide variety of network and computing environments. FIG. 8 illustrates an example of a computer system 800 that may be used to implement one or more of the embodiments described herein according to an embodiment of the invention. The computer system 800 includes sets of instructions 824 for causing the computer system 800 to perform the processes and features discussed herein. The computer system 800 may be connected (e.g., networked) to other machines and/or computer systems. In a networked deployment, the computer system 800 may operate in the capacity of a server or a client machine in a client-server network environment, or as a peer machine in a peer-to-peer (or distributed) network environment.

The computer system 800 includes a processor 802 (e.g., a central processing unit (CPU), a graphics processing unit (GPU), or both), a main memory 804, and a nonvolatile memory 806 (e.g., volatile RAM and non-volatile RAM, respectively), which communicate with each other via a bus 808. In some embodiments, the computer system 800 can be a desktop computer, a laptop computer, personal digital assistant (PDA), or mobile phone, for example. In one embodiment, the computer system 800 also includes a video display 810, an alphanumeric input device 812 (e.g., a keyboard), a cursor control device 814 (e.g., a mouse), a drive unit 816, a signal generation device 818 (e.g., a speaker) and a network interface device 820.

In one embodiment, the video display 810 includes a touch sensitive screen for user input. In one embodiment, the touch sensitive screen is used instead of a keyboard and mouse. The disk drive unit 816 includes a machine-readable medium 822 on which is stored one or more sets of instructions 824 (e.g., software) embodying any one or more of the methodologies or functions described herein. The instructions 824 can also reside, completely or at least partially, within the main memory 804 and/or within the processor 802 during execution thereof by the computer system 800. The instructions 824 can further be transmitted or received over a network 840 via the network interface device 820. In some embodiments, the machine-readable medium 822 also includes a database 825.

Volatile RAM may be implemented as dynamic RAM (DRAM), which requires power continually in order to refresh or maintain the data in the memory. Non-volatile memory is typically a magnetic hard drive, a magnetic optical drive, an optical drive (e.g., a DVD RAM), or other type of memory system that maintains data even after power is removed from the system. The non-volatile memory 806 may also be a random access memory. The non-volatile memory 806 can be a local device coupled directly to the rest of the components in the computer system 800. A non-volatile memory that is remote from the system, such as a network storage device coupled to any of the computer systems described herein through a network interface such as a modem or Ethernet interface, can also be used.

While the machine-readable medium 822 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. Examples of machine-readable media (or computer-readable media) include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 800 to perform any one or more of the processes and features described herein.

In general, routines executed to implement the embodiments of the invention can be implemented as part of an operating system or a specific application, component, program, object, module or sequence of instructions referred to as “programs” or “applications”. For example, one or more programs or applications can be used to execute any or all of the functionality, techniques, and processes described herein. The programs or applications typically comprise one or more instructions set at various times in various memory and storage devices in the machine and that, when read and executed by one or more processors, cause the computing system 800 to perform operations to execute elements involving the various aspects of the embodiments described herein.

The executable routines and data may be stored in various places, including, for example, ROM, volatile RAM, non-volatile memory, and/or cache memory. Portions of these routines and/or data may be stored in any one of these storage devices. Further, the routines and data can be obtained from centralized servers or peer-to-peer networks. Different portions of the routines and data can be obtained from different centralized servers and/or peer-to-peer networks at different times and in different communication sessions, or in a same communication session. The routines and data can be obtained in entirety prior to the execution of the applications. Alternatively, portions of the routines and data can be obtained dynamically, just in time, when needed for execution. Thus, it is not required that the routines and data be on a machine-readable medium in entirety at a particular instance of time.

While embodiments have been described fully in the context of computing systems, those skilled in the art will appreciate that the various embodiments are capable of being distributed as a program product in a variety of forms, and that the embodiments described herein apply equally regardless of the particular type of machine- or computer-readable media used to actually effect the distribution.

Alternatively, or in combination, the embodiments described herein can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description or discussed herein. In other instances, functional block diagrams and flow diagrams are shown to represent data and logic flows. The components of block diagrams and flow diagrams (e.g., modules, engines, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “another embodiment”, “in various embodiments,” or the like means that a particular feature, design, structure, or characteristic described in connection with the embodiment is included in at least one embodiment of the disclosure. The appearances of, for example, the phrases “according to an embodiment”, “in one embodiment”, “in an embodiment”, “in various embodiments,” or “in another embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments but also variously omitted in other embodiments. Similarly, various features are described which may be preferences or requirements for some embodiments but not other embodiments.

Although embodiments have been described with reference to specific exemplary embodiments, it will be evident that the various modifications and changes can be made to these embodiments. Accordingly, the specification and drawings are to be regarded in an illustrative sense rather than in a restrictive sense. The foregoing specification provides a description with reference to specific exemplary embodiments. It will be evident that various modifications can be made thereto without departing from the broader spirit and scope as set forth in the following claims. The specification and drawings are, accordingly, to be regarded in an illustrative sense rather than a restrictive sense.

Although some of the drawings illustrate a number of operations or method steps in a particular order, steps that are not order dependent may be reordered and other steps may be combined or omitted. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention, both independently and as an overall system, and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Further, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps, but not the exclusion of any other element or step or group of elements or steps. Such terms should be interpreted in their most expansive forms so as to afford the applicant the broadest coverage legally permissible in accordance with the following claims.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computing system, an input image associated with a test object;
identifying, by the computing system, a set of edges in the input image;
identifying, by the computing system, a set of circles based on the set of edges;
selecting, by the computing system, a subset of circles from the set of circles;
matching, by the computing system, the subset of circles to a set of reference circles associated with a reference object; and
generating, by the computing system, an authentication score for the test object based on the matching of the subset of circles to the set of reference circles.

2. The computer-implemented method of claim 1, wherein the selecting the subset of circles from the set of circles comprises:
calculating, for each circle of the set of circles, a confidence measure based on a number of edge pixels falling on the circle, and
selecting the subset of circles from the set of circles based on the confidence measures.

3. The computer-implemented method of claim 2, wherein, for each circle of the set of circles, the confidence measure is calculated further based on at least one of: a number of expected edge pixels for the circle, a number of edge pixels detected for the circle, and a circumference of the circle.

4. The computer-implemented method of claim 1, wherein the selecting the subset of circles from the set of circles comprises:
clustering the set of circles into a plurality of clusters, wherein the number of clusters in the plurality of clusters is determined based on the number of circles in the reference set of circles;
calculating a confidence measure for each circle in the set of circles; and
identifying, in each cluster of the plurality of clusters, a circle having the highest confidence measure within the cluster for inclusion in the subset of circles.

5. The computer-implemented method of claim 1, wherein the matching the subset of circles to a set of reference circles comprises:
measuring a radius of each circle in the subset of circles to define a set of radii;
determining an inverse radius of each radius in the set of radii to define a set of inverse radii;
multiplying each radius of the set of radii by each inverse radius of the set of inverse radii to obtain a set of scaled radii values;
obtaining a set of reference scaled radii values; and
comparing the set of scaled radii values with the set of reference scaled radii values.

6. The computer-implemented method of claim 5, wherein the obtaining the set of reference scaled radii values comprises:
measuring a reference radius of each circle in the set of reference circles to define a set of reference radii;
determining an inverse reference radius of each reference radius of the set of reference radii to define a set of inverse reference radii; and
multiplying each reference radius of the set of reference radii by each inverse reference radius of the set of inverse reference radii to obtain the set of reference scaled radii values.

7. The computer-implemented method of claim 1, wherein the generating the authentication score based on the matching of the subset of circles to the set of reference circles comprises:
comparing a set of surface textures between each circle in the subset of circles with a set of reference surface textures.

8. The computer-implemented method of claim 7, wherein the authentication score is calculated based on the comparing the set of surface textures between each circle in the subset of circles with the set of reference surface textures and the matching the subset of circles to the set of reference circles.

9. The computer-implemented method of claim 1, wherein the set of circles comprises concentric circles.

10. The computer-implemented method of claim 1, wherein the input image is an image of a ball bearing and the test object is the ball bearing, and the method further comprises: determining whether the ball bearing is authentic based on the authentication score.

11. A system comprising:
at least one processor; and
a memory storing instructions that, when executed by the at least one processor, cause the system to perform:
receiving an input image associated with a test object;
identifying a set of edges in the input image;
identifying a set of circles based on the set of edges;
selecting a subset of circles from the set of circles;
matching the subset of circles to a set of reference circles associated with a reference object; and
generating an authentication score for the test object based on the matching of the subset of circles to the set of reference circles.

12. The system of claim 11, wherein the selecting the subset of circles from the set of circles comprises:
calculating, for each circle of the set of circles, a confidence measure based on a number of edges falling on the circle, and
selecting the subset of circles from the set of circles based on the confidence measures.

13. The system of claim 12, wherein, for each circle of the set of circles, the confidence measure is calculated further based on at least one of: a number of expected edge pixels for the circle, a number of edge pixels detected for the circle, and a circumference of the circle.

14. The system of claim 11, wherein the selecting the subset of circles from the set of circles comprises:
clustering the set of circles into a plurality of clusters, wherein the number of clusters in the plurality of clusters is determined based on the number of circles in the reference set of circles;
calculating a confidence measure for each circle in the set of circles; and
identifying, in each cluster of the plurality of clusters, a circle having the highest confidence measure within the cluster for inclusion in the subset of circles.

15. The system of claim 11, wherein the matching the subset of circles to a set of reference circles comprises:
measuring a radius of each circle in the subset of circles to define a set of radii;
determining an inverse radius of each radius in the set of radii to define a set of inverse radii;
multiplying each radius of the set of radii by each inverse radius of the set of inverse radii to obtain a set of scaled radii values;
obtaining a set of reference scaled radii values; and
comparing the set of scaled radii values with the set of reference scaled radii values.

16. A non-transitory computer-readable storage medium including instructions that, when executed by at least one processor of a computing system, cause the computing system to perform:
receiving an input image associated with a test object;
identifying a set of edges in the input image;
identifying a set of circles based on the set of edges;
selecting a subset of circles from the set of circles;
matching the subset of circles to a set of reference circles associated with a reference object; and
generating an authentication score for the test object based on the matching of the subset of circles to the set of reference circles.

17. The non-transitory computer-readable storage medium of claim 16, wherein the selecting the subset of circles from the set of circles comprises:
calculating, for each circle of the set of circles, a confidence based on a number of edges falling on the circle, and
selecting the subset of circles from the set of circles based on the confidence measures.

18. The non-transitory computer-readable storage medium of claim 17, wherein, for each circle of the set of circles, the confidence measure is calculated further based on at least one of: a number of expected edge pixels for the circle, a number of edge pixels detected for the circle, a circumference of the circle.

19. The non-transitory computer-readable storage medium of claim 16, wherein the selecting the subset of circles from the set of circles comprises:
clustering the set of circles into a plurality of clusters, wherein the number of clusters in the plurality of clusters is determined based on the number of circles in the reference set of circles;
calculating a confidence measure for each circle in the set of circles; and
identifying, in each cluster of the plurality of clusters, a circle having the highest confidence measure within the cluster for inclusion in the subset of circles.

20. The non-transitory computer-readable storage medium of claim 16, wherein the matching the subset of circles to a set of reference circles comprises:
measuring a radius of each circle in the subset of circles to define a set of radii;
determining an inverse radius of each radius in the set of radii to define a set of inverse radii;
multiplying each radius in the set of radii by each inverse radius in the set of inverse radii to obtain a set of scaled radii values;
obtaining a set of reference scaled radii values; and
comparing the set of scaled radii values with the set of reference scaled radii values.
